(19) United States
(12) Patent Application Publication
(10) Pub. No.: US 2013/0034835 A1
(43) Pub. Date: Feb. 7, 2013

(54) LEARNING DEVICE AVAILABLE FOR USER CUSTOMIZED CONTENTS PRODUCTION AND LEARNING METHOD USING THE SAME

(71) Applicant: Byoung-Chul Min, Seoul (KR)

(72) Inventor: Byoung-Chul Min, Seoul (KR)

(21) Appl. No.: 13/562,862

(22) Filed: Jul. 31, 2012

(30) Foreign Application Priority Data
Aug. 1, 2011 (KR) 10-2011-0076476

(51) Int. Cl. G09B 19/00; G09B 5/00

(52) U.S. Cl. 434/169

(57) ABSTRACT

Disclosed is a learning device available for user customized contents production and a learning method using the same capable of capable of allowing a user to directly record learning contents and learn while listening to and copying the recorded contents. The present disclosure can provide a formant of recorded contents and a formant of a user's speech when a user records and plays contents to be learned and copies the played contents and provides a matching rate of the formants, thereby performing pronunciation correction while progressing learning for the user desired contents

### CROSS-REFERENCE TO RELATED APPLICATIONS

This application is based on and claims priority from Korean Patent Application No. 10-2011-0076476, filed on Aug. 01, 2011, with the Korean Intellectual Property Office, the disclosure of which is incorporated herein in its entirety by reference.

### TECHNICAL FIELD

The present disclosure relates to a learning device available for user customized contents production and a learning method using the same, and more particularly, to a learning device available for user customized contents production and a learning method using the same capable of allowing a user to directly record learning contents and learn while playing the recorded contents.

### BACKGROUND

The importance of English has been increased more and more with the specialization and globalization of industries. Many people consume time and money to learn English due to the increased importance of English.

In the past, people have learned English using books and tapes. Today, people have learned English while frequently playing various types of English related contents that are stored in electronic devices, such as a computer, a notebook, a tablet PC, an MP3, a smart phone, and the like, with the development of multimedia.

However, most of the English related contents stored in the electronic devices are purchased except for some samples, which may slightly burden people intending to learn English. People intending to learn English wants to use, for example, conversation contents with foreigners, speech or announcement of International seminar, the English related contents that are televised on media such as TV, and the like, for their self-learning of English instead of purchasing the English related contents that may be financially burdened.

To this end, a learner can perform recording if necessary while carrying a recorder. Since a learner carries various electronic devices, separately carrying a recorder is inconvenient and merely listening to the recorded contents does not necessarily help people learning English.

Further, in order to improve pronunciation of a learner, his/her pronunciation needs to be corrected by someone. However, since electronic devices merely play recorded contents and people merely copy the played contents, it is difficult to learn accurate pronunciation of foreign languages, in particular, English using electronic devices.

### SUMMARY

The present disclosure has been made in an effort to provide a learning device and a learning method using the same capable of allowing a learner to directly record immediately English broadcasting, movies, native conversation, and the like, if necessary in real life and use the recorded contents for learning.

Further, the present disclosure has been made in an effort to learn accurate pronunciation of foreign languages by visually providing sound sources and pronunciation of a learner using a speech analysis process.

In addition, the present disclosure has been made in an effort to effectively learn domestic songs and foreign songs by dividing and playing sound sources of songs in any unit such as a measure and providing scores for each unit.

An exemplary embodiment of the present invention provides a learning device available for user customized contents production, including: a user interface unit configured to input data for controlling an operation according to a selection of a user; a recording playing unit configured to record a sound source input to a mike and playing the recorded sound source; a speech recognition unit configured to recognize the played sound source and recognize a user's speech input to the mike after playing the sound source; a matching unit configured to match the sound source recognized by the speech recognition unit with the user's speech to generate matching data; and a display unit visually displaying the matching data.

The learning device available for user customized contents production may further includes: a control unit configured to perform a control to play the sound source according to a playing option set by the use; and an editing unit configured to edit the recorded sound source in a user desired form.

The speech recognition unit may use a speech analysis process stored in a memory.

The playing option may include a playing speed, a playing unit, and a repeat playing period of the sound source and the playing unit may include a word, a semantic segment, a sentence, and a paragraph.

The editing unit may include a function of deleting a part of the recorded sound source, a function of changing the recorded sound source into a text through an STT, and a function of changing a part of the changed text to another character to acquire a new sound source through a TTS.

Another exemplary embodiment of the present invention provides a learning method, including: selecting one of speech contents recorded by a user and playing the selected contents; receiving and recognizing a user's speech after the playing; matching the speech recognized in the recognizing with the speech contents to generate matching data; and providing the matching data to the user.

In the recognizing, the user's speech may be analyzed with a frequency to confirm how much energy is present in any frequency.

In the providing, the matching data may be provided in at least one of a graph and a matching percentage.

When the matching data may be a predetermined reference or less, the process may return to the playing.

The playing may further include: setting a playing speed by the user input, setting a playing unit by the user input, and setting a repeat playing period by the user input.

The playing unit may include a word, a semantic segment, a sentence, and a paragraph.

According to the exemplary embodiments of the present disclosure, it is possible to implement the active learning by allowing a user to immediately record various sound sources at any time when needed and to use the recorded sound sources for learning.

According to the exemplary embodiments of the present disclosure, it is possible to immediately secure the sound sources at the desired time by allowing a user to immediately drive the learning applications by the one-touch function if necessary so as to record the sound sources.

According to the exemplary embodiments of the present disclosure, since the user can store his/her desired various contents in the learning device and edit the stored contents according to his/her demand at no cost, he/she can progress his/her own learning without enduring a financial burden.

According to the exemplary embodiments of the present disclosure, since the pronunciation similarity can be visually confirmed by the formant comparison between the sound source and the user's speech at the time of learning, the pronunciation can be easily corrected by understanding how much the user pronunciation and the sound source (native pronunciation) are similar to each other.

According to the exemplary embodiments of the present disclosure, the user can easily determine his/her own weaknesses and concentratedly practice on his/her own weaknesses by allowing the learner to control the playing unit of the sound sources and calculate the scores corresponding to the playing unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a configuration of a learning device available for user customized contents production according to an exemplary embodiment of the present disclosure.

FIG. 2 is a flow chart illustrating a learning process using the learning device available for user customized contents production according to the exemplary embodiment of the present disclosure.

FIGS. 3A-3E are diagrams illustrating a screen displayed on a smart phone when progressively learning through the smart phone according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

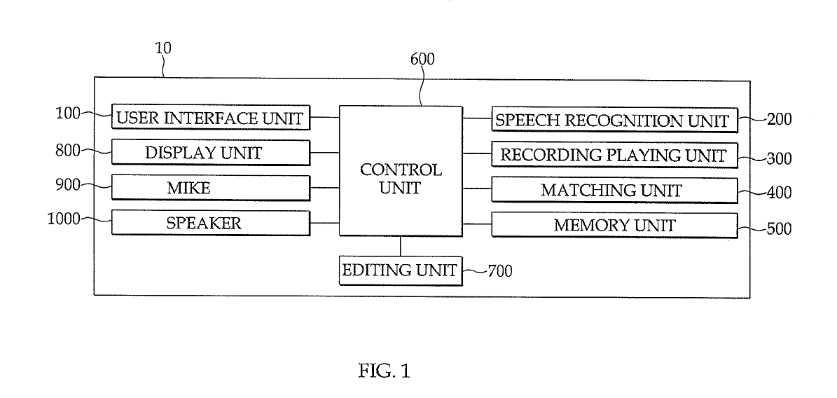

A technical configuration of a learning device available for user customized contents production 10 according to an exemplary embodiment of the present disclosure will be described with reference to FIG. 1.

As illustrated in FIG. 1, the learning device available for user customized contents production 10 may include a user interface unit 100, a speech recognition unit 200, a recording playing unit 300, a matching unit 400, a memory unit 500, a control unit 600, an editing unit 700, a display unit 800, a mike 900, a speaker 1000, a communication interface unit (not illustrated), and the like.

The user interface unit 100 generates input data by allowing a user to control an operation according to recording, editing, mode selection, and the like, of contents for learning. The user interface unit 100 may be configured of a key pad, a dome switch, a touch pad (static pressure/power failure), a jog wheel, a jog switch, and the like. In particular, when the touch pad forms a mutual layer structure together with the display unit 800 to be described below, the touch pad may be a touch screen.

The speech recognition unit 200 recognizes speech from a sound source input through the mike.

The recording playing unit 300 records the sound source, that is, user speech or the contents for learning according to the user selection and outputs the recorded contents.

The recording playing unit 300 may cooperate with a camera to record moving pictures and output the recorded contents.

The matching unit 400 matches up the contents for learning with the user speech. The matching unit 400 detects the matching degree between the user speech and the sound source to generate matching data. In case of contents for song learning formed of background sound (accompaniment sound) and a singer's voice, the matching unit 400 extracts only the signer's voice from the contents for song learning and detects a matching degree between the extracted singer's voice and the user speech, thereby generating the matching data. An algorithm for extracting only voice applies contents that have been sufficiently studied and known from the past and therefore, the detailed description thereof will be omitted herein.

The matching unit 400 provides the generated matching data to a user through the display unit 800 or the speaker 1000 or stores in the memory unit 500. Therefore, the user can effectively perform pronunciation practice so as to give speech similar to the sound source, for example, give pronunciation similar to native pronunciation that is the sound source.

The memory unit 500 stores a contents database, a user information database, a speech analysis process, text to speech (TTS), speech to text (STT), and the like.

Analog speech input to the mike 900 is changed into a digital signal by the speech analysis process. The digital signal is configured of numbers that indicate amplitude of a signal with an approximate time difference in a unit of 1/10,000 sec. The speech analysis process analyzes a frequency of a speech signal to find a formant, such that speech is analyzed.

The formant is a spectrum that indicates how much energy is present at any frequency by a graph, and the like, by analyzing a human voice with a frequency. For example, if somebody pronounces [a], [a] is heard independent of a nature of voice. The reason is that a spectrum of [a] has the same spectrum distribution independent of somebody's voice.

The TTS is referred to as speech synthesis and a technology of allowing a machine to automatically form a sound wave of voice. The TTS is a technology that records the human voice selected as a model, divides the recorded voice in a predetermined speech unit, inputs the voice with a sign to a synthesizer, and combines only the necessary speech unit according to instruction to artificially form the voice. To the contrary, the STT is a technology that recognizes the input human voice and forms the recognized voice into a text.

The control unit 600 controls a playing speed, a playing unit, a repeat playing period of the played sound source according to setting of a user. Herein, the playing unit may be words, semantic segments, sentences, and paragraphs. For example, when the set playing unit is a sentence, the sentences are broken to be output sentence by sentence, such that the user can read the output sentence.

The edition unit 700 may edit the recorded sound source in the user desired form. The editing unit 700 deletes a portion of the recorded sound source converts the recorded sound source into the text, and changes a portion of the converted text into other characters using the speech analysis process, the TTS, and the STT that are stored in the memory unit 500, thereby acquiring a new sound source.

The display unit 800 displays information that is processed by the learning device available for user customized contents production 10. In particular, the display unit 800 serves to visually display a script, a related data, a speech waveform (formant), and the like, of contents played according to a request of the playing unit 600.

When the display unit 800 and the touch pad form the mutual layer structure so as to be configured as the touch screen, the display unit 800 may be used as an input device in addition to the output device. The display unit 800 may include at least one of a liquid crystal display, a thin film transistor-liquid crystal display, an organic light-emitting diode, a flexible display, and a 3D display.

The user needs to acquire the contents for learning prior to learning. The contents for learning may be acquired by the direct recording of the user and may be downloaded from the outside using the communication interface of the learning device 10.

A method for allowing a user to directly record the contents for learning will be described in detail.

In order for the user to record the contents to be learned in the learning device, the user first drives the learning applications and then, selects the contents recording function. However, a one-touch function may be set so as to rapidly perform the recording function at the user desired moment. The one-touch function is a function of allowing a user to immediately drive learning applications by a one-time touch operation to perform recording.

A one-touch button may be set to be driven by pressing specific keys of an existing input unit and may be implemented to be generated in a part of an idle screen of a user terminal when the learning applications are installed. The contents for learning may be English news or English radio broadcasting and may be contents partially recorded while watching a movie watching, conversation contents recorded during interview with foreigners, and contents recorded during English conversation class. As such, the contents may include not only learning foreign languages and various sounds to be imitated while the contents being repeatedly listened.

For example, the one-touch function may record songs, a voice of a specific celebrity, the cries of animals, and the like, and may be used to imitate and practice while playing the recorded contents. Even in this case, the one-touch function provides a matching rate between the pre-recorded sound source and a voice practiced by a user, thereby attracting the more interest of the user.

In addition, when the contents for learning interworks with a camera, the contents for learning may also be recorded as moving pictures.

The recorded contents for learning may be used as they are if necessary and may be variously edited according to the operation of the user. For example, the editing such as erasing the specific words, vocabularies, sentences, and or the like, of the sound sources can be performed. In addition, the input sound sources (contents for learning) are converted into texts using the speech to text (STT) and then, stored in the memory and may also be displayed on the display unit 800 at the time of playing the sound sources so as to be provided to the user. The editing for partially changing the sound sources in a script of contents is performed and then, new contents for learning may also be acquired using the TTS.

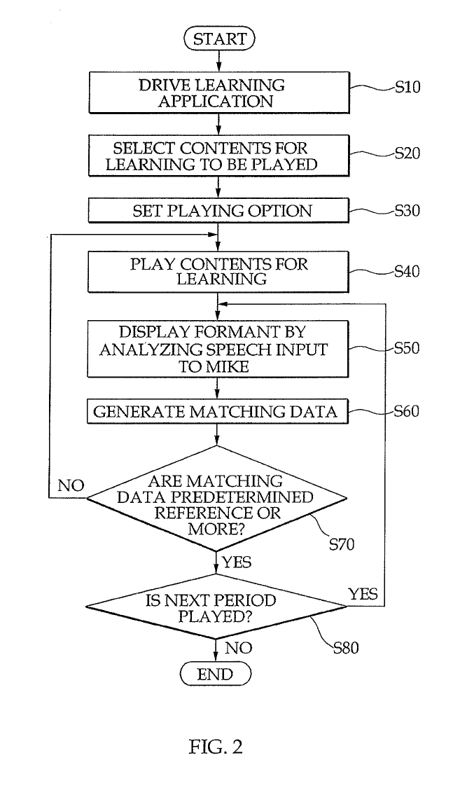

FIG. 2 is a flow chart illustrating a process of performing learning using the acquired contents for learning according to an exemplary embodiment of the present disclosure.

First, the user drives the learning applications installed in the learning device (S10). As the learning device, any electronic device such as computer, notebook, tablet PC, smart phone, and the like, that can drive the learning applications can be used.

The user selects the contents for learning to be played by operating the user interface of the learning device (S20) and sets the playing option of the selected contents for learning (S30). The playing option includes the playing speed, the playing unit, and the repeat playing period, and the like.

The playing speed means a speed that plays the contents for learning. And the playing speed and may be selected to play the contents for learning faster or slower than the original contents for learning according to the playing option.

The playing unit may mean a unit in which the contents for learning are played. The playing unit may be words, semantic segments, sentences, and paragraphs, and may be a measure, a word, and a passage in the case of the contents for song learning.

The learning device divides the contents for learning in the set playing unit and breaks and plays the contents for learning in the playing unit. Here, the ‘breaks and plays” means that any playing unit is played, stops for predetermined time, and then, is played.

The repeat playing period means a repeated period at the time of playing and the user may select a period in which the playing repeat is set in the contents for learning. The learning device repeatedly plays only the period in which the playing repeat is set.

The playing option of the learning device may be set at each time of learning, but when the first setting is designated as the basic setting, the setting of the playing option is not omitted until the user performs a separate operation and the contents for learning are played according to the basic setting at the time of playing. When the user operates the user interface to instruct the playing of the contents for learning to the learning device, the contents for learning is played according to the set playing option (S40).

When the contents for learning are played, the formant of the played contents for learning is provided to the display unit 800. In addition, the texts of the contents for learning may be displayed in a part of the display unit 800 using the STT according to the setting of the user.

When the user hears and imitates the contents for learning played according to the playing unit, the user's speech is input to the mike 900 and the formant of the input user's speech is provided to the display unit 800 (S50).

The user's speech input through the mike 900 is analyzed by the speech analysis processor and the voice formant generated according to the analysis may be filtered and provided by faster Fourier transform (FFT). When noise is removed by the filtering, the quality of signal processing can be improved. The filtered formant may be visualized by a graph, and the like, and stored.

Therefore, the user can confirm his/her own pronunciation while seeing a frequency band changed according to pronunciation with the eyes in real time.

For example, a Korean fricative sound / [symbol] / and an English fricative sound /s/ have different homorganics that causes a contact of a tongue within a mouth and therefore, a frequency of voice generated at the time of pronunciation is different. When this is FFT-transformed, the Korean fricative sound / [symbol] / has no sound of a low band (0 to 3000 Hz) and has the largest volume distributed around a middle band of 6000 Hz. On the other hand, it can be visually confirmed from the formant that the English fricative sound /s/ has a smaller low-band frequency volume and a lager high-band frequency volume of 8000 Hz or more, as compared with / [symbol] /.

The matching unit 400 matches the recognized voice to the played contents for learning to generate the matching data (S60).

In order to generate the matching data, the formant of the corresponding contents for learning stored in the memory unit 500 is provided to the matching unit 400 at the time of playing the contents for learning. The formant is referred to as a first formant. In addition, the formant of the user voice input to the mike is provided to the matching unit 400. The formant is referred to as a second formant.

The matching unit 400 matches the firs formant and the second formant and then, provides the generated matching data to the display unit 800.

The matching data, which are an evaluation for learning including the matching rate, are provided as scores obtained by quantization or digitalization such as percentage, scores, and the like, that can be easily identified by a user. The learner may detect how much his/her own pronunciation is improved every time through the scores. The scoring can arouse learning motive of a learner.

When it is determined that the matching data are a predetermined or more (S70), for example, the matching rate is 90% or less, the process returns to S30 and therefore, the corresponding portion may be set so as to be played again. When the matching data are a predetermined reference or more, a subsequent playing period is played (S80).

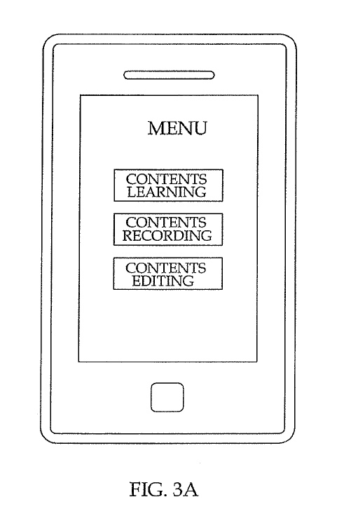

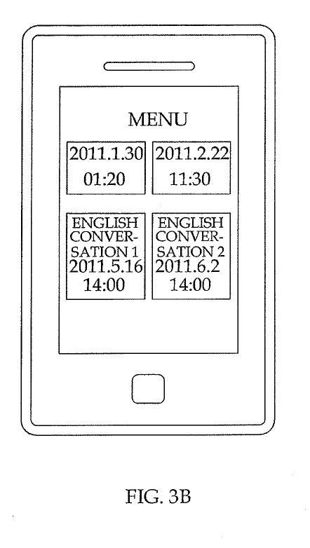

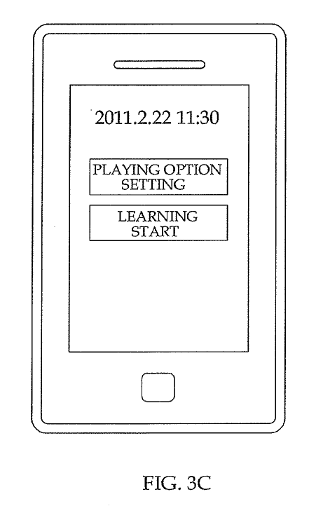

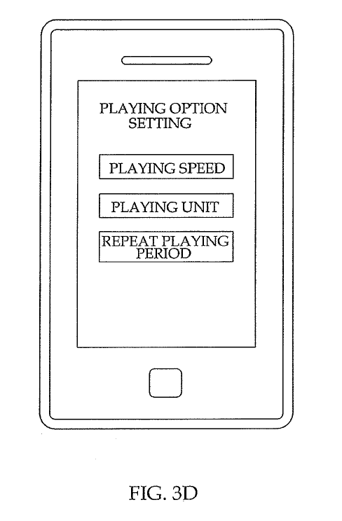

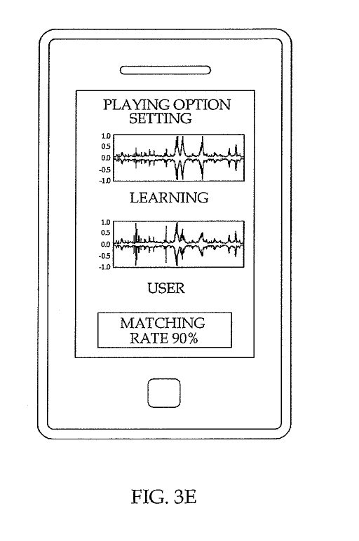

A process of performing learning by driving learning applications through a smart phone according to the exemplary embodiment of the present disclosure will be described with reference to FIG. 3.

First, the user touches and drives the learning applications that are displayed on a screen of a smart phone in an icon form. The learning applications may be downloaded through an application providing server such as an application store, and the like.

When the learning applications are driven, as illustrated in FIG. 3A, menus such as learning start, contents recording, contents editing, and the like, are displayed on the screen of the smart phone.

When the user selects the contents recording, the recording starts and when the recording ends, the corresponding recording contents are generated in an icon form and displayed on the screen of the smart phone, as illustrated in FIG. 3B. The generation date and time are displayed in an icon and a title, and the like, may be put in the icon by using the editing function later. In the case of the recording, the representative still image of the recorded moving pictures may be displayed in icon.

When the user selects the contents editing, the contents for learning are each displayed on the screen in the icon form as illustrated in FIG. 3B. The user confirms the icon to select and touch the contents for learning to be edited.

The contents are partially deleted by pressing an erasing button during playing the contents for learning or when the script of the contents for learning is present, the script is confirmed to erase the portion to be deleted, thereby forming a blank. Alternatively, new contents for learning can be produced by cutting a part of the contents for learning or attaching the contents for learning to another contents for learning. When the editing ends, a completion button is touched.

When the user selects the contents learning, the contents for learning stored in the smart phone are each displayed on the screen in the icon form. The user confirms the icon to select and touch the contents for learning to be learned.

When the user touches the screen, as illustrated in FIG. 3C, the ‘playing option setting’ and the ‘learning start’ of the selected contents for learning are displayed.

When the user selects and touches the playing option setting, as illustrated in FIG. 3D, the ‘playing speed’, ‘playing unit’, and ‘repeat playing period’ are each displayed and the user touches a button to set his/her desired playing speed, playing unit, repeat playing period and then, touches the completion button to perform a change to the set playing option. When the playing option is changed, as illustrated in FIG. 3C, the ‘playing option’ and the ‘learning start’ may be displayed again.

As illustrated in FIG. 3C, when the ‘learning start’ is touched, the selected contents for learning is played according to the set playing option.

At the time of playing, the corresponding script (text) may be displayed on the screen, together with the native formant of the contents for learning.

When the user speaks the played contents according to the native pronunciation, the user pronunciation is recorded to display the user's formant on the screen (see FIG. 3E) and the scores for the user pronunciation are displayed in the corresponding area of the screen. When the scores are below a predetermined score, the corresponding period may be played again and when the scores are a predetermined score or more, the subsequent period is played.

The user may end the playing at any time during the learning and at the time of ending, the playing period, and the like, is stored. Next, learning continued to the previous learning may be progressed at the time of starting the next learning and may be progressed again from the beginning.

Meanwhile, the exemplary embodiments of the present disclosure implement the learning method using the recordable learning device having the speech analysis process described above as a software program and record the program in a predetermined computer readable recording medium and as a result, may be applied to various apparatuses.

For example, the recording medium may be a hard disk, a flash memory, a RAM, a ROM, and the like, as an internal type of each playing apparatus or an optical disk such as CR-R and CD-RW, a compact flash card, a smart media, a memory stick, a multimedia card, and the like, as an external type thereof.

In this case, programs recorded in the computer readable recording medium may be executed by including selecting and playing one of at least one speech contents recorded by the user, receiving and recognizing the user's speech by the speech recognition processor, generating the matching data by matching the voice recognized in the recognizing to the speech contents, and providing the matching data to the user.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A learning device available for user customized contents production, comprising:
a user interface unit configured to input a input data for controlling an operation according to a selection of a user;
a recording playing unit configured to record a sound source input to a mike and playing the recorded sound source;
a speech recognition unit configured to recognize the played sound source and recognize a user's speech input to the mike after playing the sound source;
a matching unit configured to match the sound source recognized by the speech recognition unit with the user's speech to generate matching data;
a display unit configured to visually display the matching data; and
a control unit configured to perform a control to play the sound source according to a playing option set by the user,
wherein the playing option includes a playing speed, a playing unit, and a repeat playing period of the sound source.

2. The learning device of claim 1, further comprising:
an editing unit configured to delete or change a part of the recorded sound source.

3. The learning device of claim 1, wherein the recording playing unit cooperates with a camera to record moving pictures and plays the recorded moving pictures.

4. The learning device of claim 1, wherein the user interface unit further includes a one-touch function button and the one-touch function button is a button for performing recording by immediately driving learning applications through a one-time button operation so as to perform a recording function at the user desired moment.

5. The learning device of claim 1, wherein the speech recognition unit performs a speech analysis function using a speech analysis process stored in a memory.

6. The learning device of claim 1, wherein the playing unit includes a word, a semantic segment, a sentence, and a paragraph.

7. The learning device of claim 1, wherein the playing unit includes a measure, a word, and a passage.

8. The learning device of claim 1, wherein the matching unit extracts only a human voice so as to be matched with the user's speech when the type of the recognized sound source is configured of a background sound and the human voice.

9. The learning device of claim 2, wherein the editing unit includes a function of deleting a part of the recorded sound source, a function of attaching a part of the recorded sound source to a part of another sound source, a function of changing the recorded sound source into a text through an STT, and a function of changing a part of the changed text to another character to acquire a new sound source through a TTS.

10. A learning method using a speech analysis process by the learning device, comprising:
playing the selected contents of downloaded contents or recorded contents through an operation of a one-touch function according to setting of a playing option;
receiving and recognizing a user's speech input to a mike after the playing;
matching speech recognized in the recognizing with a sound source of speech contents played in the playing to generate matching data; and
providing the matching data to the user;
wherein the setting of the playing option includes playing speed setting, playing unit setting, and repeat playing period setting.

11. The learning method of claim 10, wherein in the receiving and recognizing, the user's speech is analyzed with a frequency to confirm how much energy is present in any frequency.

12. The learning method of claim 10, wherein in the providing, the matching data are displayed in a form of at least one of a graph and a matching percentage.

13. The learning method of claim 10, wherein when the matching data are a predetermined reference or less, the process is returns to the playing.

14. The learning method of claim 10, wherein the playing unit includes a word, a semantic segment, a sentence, and a paragraph.

15. The learning method of claim 10, wherein the playing unit includes a measure, a word, and a passage.

16. The learning method of claim 10, wherein in the matching data, when the played contents are added with a background sound and a human voice, the matching data are formed by extracting only the human voice so as to be matched with the user's speech input to the mike after the playing.

17. A computer readable recording medium recording programs for executing the process by claim 10.
